(19) United States
(12) Patent Application Publication
(10) Pub. No.: US 2002/0140632 A1
(43) Pub. Date: Oct. 3, 2002

(54) Console lid mounted screen

(75) Inventor: Sachin V. Shah, Troy, MI (US)

Correspondence Address: BRINKS HOFER GILSON & LIONE, P.O. BOX 10395, CHICAGO, IL, 60610, US

(73) Assignee: Visteon Global Technologies, Inc.

(21) Appl. No.: 09/823,587

(22) Filed: Mar. 30, 2001

(51) Int. Cl. G09G 5/00

(52) U.S. Cl. 345/5

(57) ABSTRACT

A console lid mounted screen is provided having a console lid positioned over a console for pivotal movement relative to the console and a display screen mounted within a frame attached within an interior compartment defined in the console lid. The frame is pivotally connected to the console lid so that the frame and the screen can move relative to the console lid.

### FIELD OF THE INVENTION

The invention relates generally to the field of automobile display screens. In particular, the invention relates to a display screen that can be mounted in the console lid of an automobile.

### DESCRIPTION OF THE RELATED ART

Many present-day automobiles incorporate a viewing screen for entertainment or information purposes. Many methods exist for providing these screens in different positions in automobiles. The screen position depends on the viewer and where they are situated in the automobile.

Some manufacturers have incorporated a viewing screen on the dashboard near the audio controls. This position allows viewing by both the front seat passengers and to a lesser extent, the passengers in the back seats. Another method of mounting a view screen is to position it on a roof console near the reading lights of the automobile. This mounting location is often used in minivans and sport utility vehicles, where the roof profile is higher. Positioning the screen in this location allows the backseat passengers to easily see the screen without neck strain. However, the front seat occupants cannot see the screen as well.

A third option is described in U.S. Pat. No. 4,982,996. The '996 patent discloses a television set in the storage console between the front seats. In this position, the back seat passengers can view the screen but the front seat passengers cannot. A disadvantage to this position is the loss of some of the storage space in the center console.

Finally, view screens are often installed on the headrests or backs of the front seats. This allows the back seat passengers to have their own individual view screen. However, this position can be dangerous to back seat passengers in the event of a crash, as their forward momentum could propel them into the screen.

A disadvantage to all of the above positions of automotive display screens is that they are continuously in view. There is no way to hide the screens when the occupants leave the car. This can result in theft or vandalism of the screens. It is desirable to mount an automotive display screen in a manner that is safe to all the passengers, easily viewable by the passengers, but that can be hidden from outside view when necessary without losing a significant amount of storage space within the vehicle.

### BRIEF SUMMARY OF THE INVENTION

In one embodiment of the present invention, a console lid is positioned over a console for pivotal movement relative to the console and a display screen is mounted within a frame attached within an interior compartment defined in the console lid. The frame is pivotally connected to the console lid so that the frame and the screen can move relative to the console lid.

In an alternate embodiment of the present invention, a frame is pivotally attached to a console lid using at least one friction pinion. A display screen is mounted within the frame and the console lid has a compartment defined in it to receive the frame. The bottom side of the compartment is composed of a substantially rigid material.

### BRIEF DESCRIPTION OF SEVERAL VIEWS OF THE DRAWINGS

FIG. 1 is a view of an embodiment of the invention with the display screen in an open position viewed from the rear seats of a vehicle;

FIG. 2 is a close-up view of the friction pinions of the embodiment of FIG. 1;

FIG. 3 is a side view of the embodiment of FIG. 1 with the display screen in an open position;

FIG. 4 is a view of the embodiment of FIG. 1 with the display screen in a closed position viewed from the rear seats of a vehicle;

FIG. 5 is a side view of the embodiment of FIG. 1 with the display screen in a closed position; and

FIG. 6 is a side view of the embodiment of FIG. 1 with the console lid in an open position.

### DETAILED DESCRIPTION OF THE PREFERRED EMBODIMENTS OF THE INVENTION

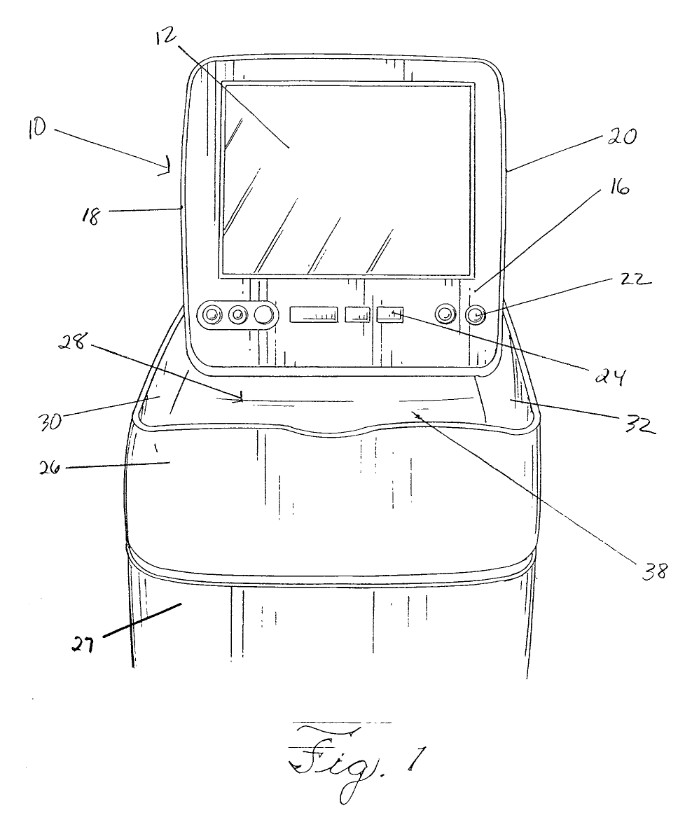

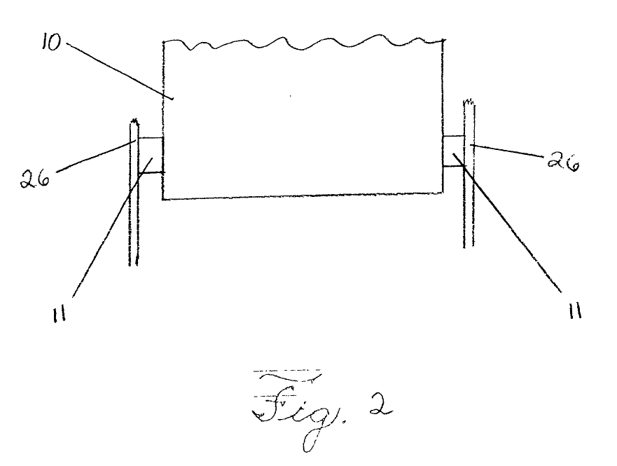

Referring in combination to FIGS. 1-3, a preferred embodiment of the present invention is shown with the frame 10 and display screen 12 in an open and viewable position. FIG. 1 shows the present invention as seen by a passenger seated in the back seat of a vehicle. A thin-profile display screen 12, such as an LCD screen as known in the art, is enclosed within a movable frame 10 with a top side 14, a bottom side 16, a left side 18 and a right side 20. The display screen 12 is preferably positioned substantially in the center of the frame 10. Optional buttons 22 and other controls 24 may be mounted on the bottom side 16 of the frame 10 in any position around the display screen 12. Another option would be to design the screen 12 to be touch sensitive, thus negating the need for controls 24 and buttons 22 mounted on the frame 10 itself and allowing for a larger screen 12.

Preferably, the frame 10 has friction pinions 11 extending from the left side 18 and the right side 20 of the frame 10. These friction pinions 11 provide a pivotable connection to the console lid 26. The console lid 26 is preferably mounted on a center console 27 of an automobile, between the driver and front passenger seats (not shown). The friction pinions 11 allow the frame 10 to be adjusted to virtually any angle relative to the console lid 26. A passenger can adjust the frame 10 to a desired viewing position, and the friction pinions 11 will maintain that position until further adjustment. This feature allows adjustment of the display screen 12 to compensate for the level of light available and the position of the viewer. The position of the display screen 12 in between the rear seat passengers also minimizes the danger of a passenger hitting the display screen 12 in the event of an accident, since the screen 12 is not directly in front of the passengers.

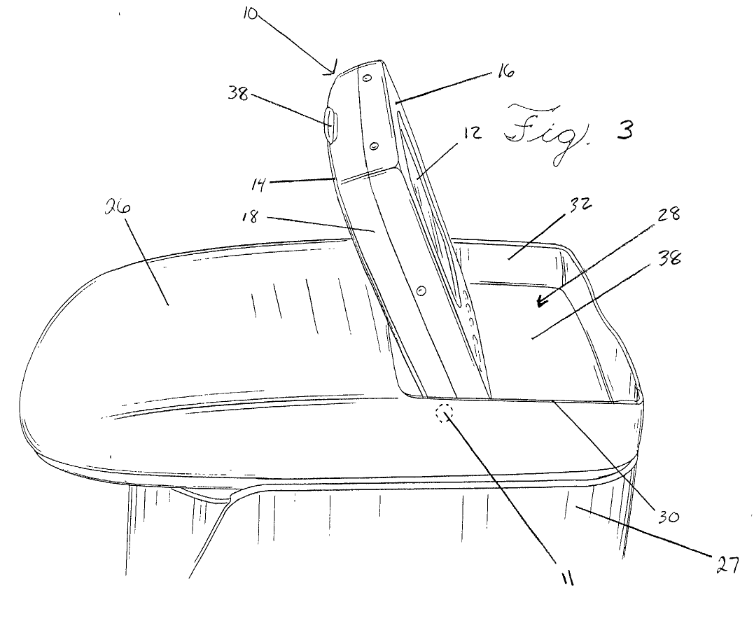

As seen in FIG. 3, the frame 10 has a substantially thin profile, preferably around 1″ in thickness. The console lid 26 remains thin and light. The friction pinions 11 of the frame 10 are attached to the left side 30 and the right side 32 of an interior compartment 28 formed in the console lid 26. The interior compartment 28 is preferably large enough to accommodate the frame 10 in the closed position. Preferably, the size of the interior compartment 28 allows a substantially snug fit for the frame 10 in the compartment 28 without leaving a large space between the frame 10 and the sides 30, 32 of the interior compartment 28. The depth of the interior compartment 28 is preferably large enough to accommodate the frame 10 without leaving a large amount of empty space between the frame 10 and the bottom side 36 of the interior compartment 28. Again, this allows the console lid 26 to remain thin and light, maintaining the size and shape of a console lid 26 without a display screen 12 mounted in it.

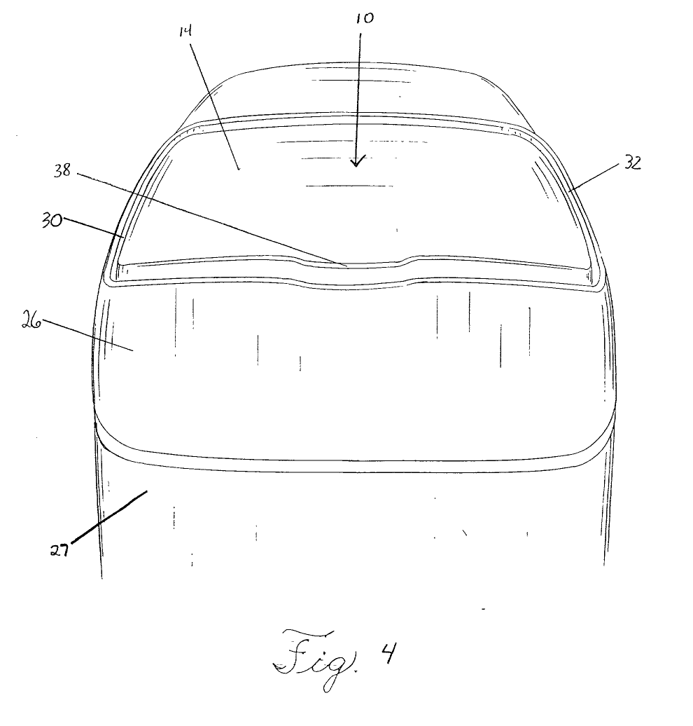

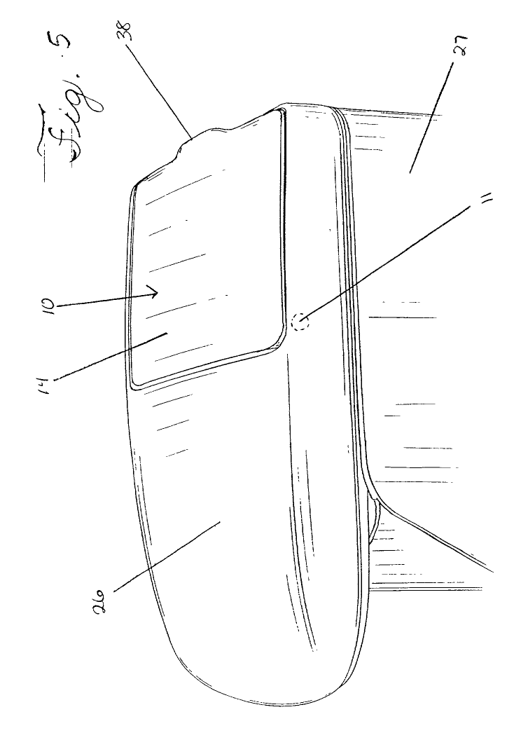

Referring in combination to FIGS. 4 and 5, a preferred embodiment of the invention is shown with the frame 10 in a closed position in the console lid 26. The console lid 26 is also in its closed position. Preferably, the top side 14 of the frame 10 has a flange 38 allowing a passenger to grip the frame 10 and pivot it to an open position as shown in FIGS. 1 & 3. The flange 38 also prevents the frame 10 from pivoting any further into the interior compartment 28 by coming into contact with the console lid 26. Since the friction pinions 11 hold the frame 10 in any stationary position, including the closed position, there is no need to integrate a locking mechanism to keep the frame 10 in a closed position. However, this feature could be added to the interior compartment 28 for added security. In the closed position, the frame 10 and the top of the console lid 26 maintain a substantially flat profile that the driver or front seat passenger can use for an armrest as generally used in vehicles with center storage consoles 27.

When the frame 10 is in the closed position, the display screen 12 is hidden from view. This reduces the risk of theft. The console lid 26 looks like a console lid 26 without a display screen 12 inside. A thief cannot see the display screen 12.

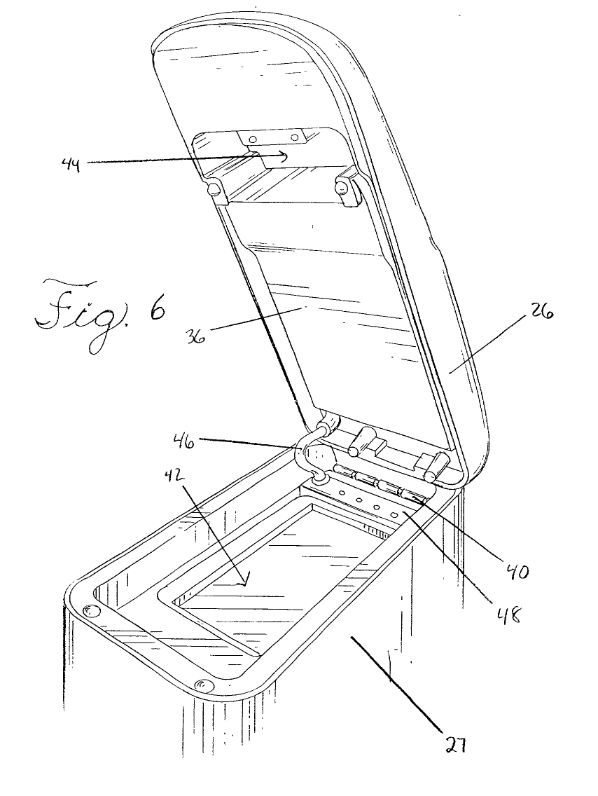

FIG. 6 shows the console lid 26 in its open position. A hinge 40 allows the console lid 26 to move between the closed and the open positions. In the open position, the storage bin 42 of the console is accessible. The friction pinions 11 in the frame 10 keep the frame 10 from opening when the console lid 26 is in the open position. It is also possible to open the console lid 26 when the frame 10 is in the open position as shown in FIGS. 1 and 3.

The bottom side 36 of the interior compartment 28 preferably is constructed of a rigid material such as plastic or metal. This material prevents the display screen 12 from damage that could be caused by contact with items in the storage bin 42 of the console 27. The bottom side 36 of the interior compartment 28 preferably does not extend past the console lid 26 into the storage bin 42. This allows full use of the storage space provided in the storage bin 42. The section 44 of the console lid 26 extending past the interior compartment 28 can be hollow as shown or solid.

Preferably, a conduit tube 46 containing connections to the battery (not shown) and other components, such as the speaker system of the vehicle or playback devices such as a VCR, extends from the bottom side 36 of the interior compartment 28 and into a closed off section 48 of the storage bin 42. The conduit tube 46 is preferably flexible so that it is not damaged when the console lid 26 is moved between its open and closed positions.

It should be noted that there could be a wide range of changes made to the present invention without departing from its scope. The display screen 12 could be larger or smaller and the buttons 22 and controls 24 on the frame 10 could be positioned differently. The screen 12 could be touch sensitive, making the inclusion of separate buttons 22 and controls 24 unnecessary. Another option would be to give the screen 12 wireless control capabilities, and position the controls elsewhere in the vehicle or even on a separate remote unit. The frame 10 is large enough to include many different arrangements of this type. Depending on the method of controlling the display screen 12, the conduit tube 46 enclosing the connections to other devices may be enlarged, or eliminated. A flat electrical cable could also be used in place of the conduit tube 46. If a flat electrical cable is used, it could be routed behind the hinge 40 so there would be no visible wiring. If the battery is included in the frame 10 itself, and a wireless control means is used, there may be no need for a conduit tube 46 at all. The location of the interior compartment 28 on the console lid 26 could also be moved to any location on the console lid 26, and the frame 10 would be moved accordingly. Instead of friction pinions 11, another type of pivoting mechanism could be used to allow movement of the frame 10. A locking mechanism could be installed in the console lid 26 or the frame 10 itself to keep the frame 10 in an open or closed position, as well as any position in between. Thus, it is intended that the foregoing detailed description be regarded as illustrative rather than limiting and that it be understood that it is the following claims, including all equivalents, which are intended to define the scope of the invention.

What is claimed is:

1. A console lid mounted screen comprising:
a console lid positioned over a console for pivotal movement relative thereto; and
a display screen mounted in a movable frame pivotally positioned within an interior compartment of said lid to allow said frame and said screen to move between at least two positions relative to said lid.

2. The console lid mounted screen of claim 1, wherein said lid can pivot between an open position and a closed position.

3. The console lid mounted screen of claim 2, wherein when said lid is in said open position, the storage bin of said console is accessible.

4. The console lid mounted screen of claim 3, wherein the bottom side of said interior compartment is comprised of a substantially rigid material.

5. The console lid mounted screen of claim 4, wherein one of said positions of said frame is the closed position and when said frame is in said closed position, said screen is hidden from view and said lid has a substantially flat profile.

6. The console lid mounted screen of claim 5, wherein said frame is attached to said lid with at least one friction pinion, allowing said frame to remain stationary at any angle relative to said lid.

7. A console lid mounted screen comprising:
a frame pivotally attached to a console lid with at least one friction pinion;
a display screen defined within said frame;
said console lid having a compartment defined therein to receive said frame; and
the bottom side of said compartment having a substantially rigid surface.

8. The console lid mounted screen of claim 7, wherein said frame can pivot relative to said console lid and said friction pinion allows said frame to remain stationary in any position relative to said console lid.

9. The console lid mounted screen of claim 8, said frame having a closed position wherein said frame forms a substantially flat surface with said console lid and said screen is hidden from view.

10. The console lid mounted screen of claim 9, wherein said console lid has a hinge providing a pivotable connection to a console.

11. The console lid mounted screen of claim 10, wherein said console lid has an open and a closed position.
